(19) United States
(12) Patent Application Publication
(10) Pub. No.: US 2025/0296106 A1
(43) Pub. Date: Sep. 25, 2025

(54) ATOMIZATION DEVICE SPRAYING METHOD

(71) Applicant: HANGZHOU EAVISION INTELLIGENT CONTROL TECHNOLOGY CO., LTD., Hangzhou (CN)

(72) Inventors: Xinyu WANG, Suzhou (CN); Dalei SONG, Suzhou (CN); Houchen LIU, Suzhou (CN); Yang SHAO, Suzhou (CN)

(73) Assignee: HANGZHOU EAVISION INTELLIGENT CONTROL TECHNOLOGY CO., LTD., Hangzhou (CN)

(21) Appl. No.: 18/863,347

(22) PCT Filed: Jan. 13, 2023
(86) PCT No.: PCT/CN2023/072031

§ 371 Date: Nov. 6, 2024

(30) Foreign Application Priority Data
Jun. 16, 2022 (CN) 202210679263.4

(51) Int. Cl. B05B 12/08; B05B 3/10

(52) U.S. Cl. CPC B05B 12/082; B05B 3/1007; B05B 3/1078

(57) ABSTRACT

An atomization device spraying method is provided. The atomization device includes a first atomization disk and a second atomization disk that are coaxially disposed and rotate in opposite directions, and the diameter of the first atomization disk is smaller than the diameter of the second atomization disk. The atomization device spraying method includes: obtaining spraying parameters of the atomization device; determining a target particle size D_{F} of target fog droplets; adjusting, based on the spraying parameters and a preset model, a rotating speed N of the second atomization disk to a target rotating speed for outputting the target fog droplets with the target particle size D_{F}, where the preset model is built by at least a secondary atomization factor α determined based on the rotating speed N of the second atomization disk; and performing spraying through the target fog droplets with the target particle size D_{F}.

### CROSS REFERENCE TO THE RELATED APPLICATIONS

This application is the national phase entry of International Application No. PCT/CN2023/072031, filed on Jan. 13, 2023, which is based upon and claims priority to Chinese Patent Application No. 202210679263.4, filed on Jun. 16, 2022, the entire contents of which are incorporated herein by reference.

### TECHNICAL FIELD

The present invention relates to the field of the atomization technology, and in particular to an atomization device spraying method.

### BACKGROUND

Atomization means dispersion of liquid into tiny droplets through a nozzle or high-velocity air streams. A plurality of atomized and dispersed droplets can float in the air, thereby increasing a contact area with a sprayed object and improving spraying effect. Liquid atomization methods include pressure atomization, gas atomization, centrifugal force atomization, centrifugal force atomization, acoustic atomization, and the like. Liquid is directed to be formed into small droplets through a special device, and the small droplets are sprayed out in the form of fog.

A particle size of the fog droplets has a decisive influence on final spraying effect. Target fog droplets with a large particle size have a large mass. Therefore, the droplets are characterized with great kinetic energy, a fast sedimentation speed, resistance to drift, and a slow evaporation rate, and easily bounce when contacting crop leaves (namely, a lower-level concept of a sprayed object). Therefore, agricultural chemical liquid cannot effectively adhere to surfaces of the crop, and there are technical defects such as the loss of the agricultural chemical liquid and the contamination of soil (or water) caused by the agricultural chemical liquid. A particle size of target fog droplets produced by a centrifugal atomization device in the prior art is usually approximately 70 microns, and atomization of the fog droplets with a smaller particle size cannot be implemented. In this case, even if a centrifugal atomization speed is increased, a smaller fog droplet particle size cannot be achieved, there is a defect that a final fog droplet particle size is uncontrollable, and structure and control parameters of the atomization device cannot be reasonably adjusted based on a rotating speed, a diameter, and other parameters of an atomization disk and the selection of a preset particle size range, so that qualitative and quantitative adjustment of the particle size of the target fog droplets cannot be implemented.

In view of this, an atomization and spraying method and an atomization device that produces atomization in the prior art are necessarily improved, to resolve the above problems.

### SUMMARY

The present invention is intended to disclose an atomization device spraying method, to resolve the above technical defects, and to specially enable a target particle size D_{F} formed by rotation of the atomization device including a first atomization disk and a second atomization disk that rotate in opposite directions to be a set value or approximate to the set value, so that qualitative and quantitative adjustment of the target particle size D_{F} can be implemented.

To achieve the above objective, the present invention provides an atomization device spraying method, where an atomization device includes a first atomization disk and a second atomization disk that are coaxially disposed and rotate in opposite directions, the diameter of the first atomization disk is smaller than the diameter of the second atomization disk, and the method includes:
obtaining spraying parameters of the atomization device;
determining a target particle size D_{F} of target fog droplets;
adjusting, based on the spraying parameters and a preset model, a rotating speed N of the second atomization disk to a target rotating speed for outputting the target fog droplets with the target particle size D_{F}, where the preset model is built by at least a secondary atomization factor α determined based on the rotating speed N of the second atomization disk; and
performing spraying through the target fog droplets with the target particle size D_{F};
the preset model is the product of an initial fog droplet particle size D₁ output by the first atomization disk and the secondary atomization factor α.

The secondary atomization factor α is determined by the following formula:

$$α = 5.87 \times 1 {0}^{- 9} \times {N}^{2} - 2.18 \times 1 {0}^{- 4} \times N + 2.15 .$$

As a further improvement of the present invention, the atomization device spraying method further includes: adjusting the spraying parameters, and adjusting the target particle size D_{F} of the target fog droplets based on the preset model, where the spraying parameters include a combination of any one or more of the diameter d₁ of the first atomization disk, a liquid density ρ, a liquid flow quantity Q, and a rotating speed N₁ of the first atomization disk.

As a further improvement of the present invention, the initial fog droplet particle size D₁ is determined by the following formula:

$${D}_{1} = \frac{{k}_{1} \times {( ρ \times Q )}^{{k}_{2}}}{{( {N}_{1} \times {d}_{1} )}^{{k}_{3}}} ;$$

where a parameter k₁ is a first empirical coefficient, a parameter k₂ is a second empirical coefficient, and a parameter k₃ is a third empirical coefficient.

As a further improvement of the present invention, the spraying parameters include: a quantity n of guide grooves and/or the height h of the guide groove in the first atomization disk; and
the initial fog droplet particle size D₁ is determined by the following formula:

$${D}_{1} = \frac{{k}_{5} \times {( ρ \times Q )}^{{k}_{2}}}{{( {N}_{1} \times {d}_{1} )}^{{k}_{3}}} \times {( h \times n )}^{{k}_{4}} ;$$

where a parameter k₂ is a second empirical coefficient, a parameter k₃ is a third empirical coefficient, a parameter k₄ is a fourth empirical coefficient, and a parameter k₅ is a fifth empirical coefficient.

As a further improvement of the present invention, the atomization device spraying method further includes:
respectively adjusting the rotating speed N₁ of the first atomization disk and the rotating speed N of the second atomization disk to respective target rotating speeds based on the diameter d₁ of the first atomization disk, the liquid density ρ, the liquid flow quantity Q, and the preset model, to output the target fog droplets with the target particle size D_{F}.

As a further improvement of the present invention, the rotating speed N₁=∈[15000 rpm, 30000 rpm], and a difference between the rotating speed N₁ of the first atomization disk and the rotating speed N of the second atomization disk is greater than or equal to 5,000 rpm.

Compared with the prior art, the present invention has the following beneficial effects.

In this application, the rotating speed N of the second atomization disk is adjusted, based on the spraying parameters and the preset model, to the target rotating speed for outputting the target fog droplets with the target particle size D_{F}, and the target particle size D_{F} of all of the target fog droplets output by the atomization device may be a set target particle size D_{F} by adjusting the rotating speed N of the second atomization disk, ensuring qualitative and quantitative adjustment of the target particle size D_{F}.

### BRIEF DESCRIPTION OF THE DRAWINGS

FIG. 1 is a three-dimensional diagram of an atomization device for which an atomization device spraying method is used in an embodiment according to the present invention;

FIG. 2 is a three-dimensional diagram of an atomization device for which an atomization device spraying method is used in another embodiment according to the present invention; and

FIG. 3 is a schematic diagram of a fitting curve determined based on a polynomial fitting function which a tested standard value of a target particle size of target fog droplets finally generated by a first atomization disk and a second atomization disk included in the atomization device contained in FIG. 1 or FIG. 2 at different target rotating speeds and a secondary atomization factor α of a theoretical value of a target particle size D_{F} are determined dependent on.

### DETAILED DESCRIPTION OF THE EMBODIMENTS

The present invention is described in detail below in combination with implementations shown in the accompanying drawings, but it should be noted that these implementations are no restrictions on the present invention, and functions, methods, or equivalent transformations or substitutions in a structure made by those skilled in the art according to these implementations are within the scope of protection of the present invention.

An atomization device spraying method (hereinafter referred to as a “spraying method”) and an atomization device based on the spraying method disclosed in this application are intended to output target fog droplets with a target particle size D_{F} of a set value or a value approximate to the set value by the atomization device, to implement qualitative and quantitative adjustment of the target particle size D_{F}. The fog droplet particle size D_{F} of the set value or a value approximate to the set value of the target fog droplet in this application can be arbitrarily selected in a range of target particle sizes D_{F} that the atomization device can objectively output, and a rotating speed N₁ of a first atomization disk, the diameter d₁ of the first atomization disk, a liquid density ρ, a liquid flow quantity Q, a quantity n of guide grooves, or the height h of the guide groove are separately or partially combined as spraying parameters and further used as variables for determining an initial fog droplet particle size D₁. After the spraying parameters are determined, for example, when a type of liquid to be sprayed, physical and chemical indicators such as a liquid concentration, the rotating speed N₁ of the first atomization disk, and the diameter d₁ of the first atomization disk are determined, the fog droplet particle size can be determined by D_{F}=D₁×α (namely, one of the variables can be deduced and calculated based on a preset model). In particular, the target fog droplets with a set target particle size D_{F} can be output by adjusting a rotating speed N of a second atomization disk to a target rotating speed. The spraying parameters such as the type of liquid, the physical and chemical indicators such as the liquid concentration, the rotating speed N₁ of the first atomization disk, and the diameter d₁ of the first atomization disk for spraying by the entire atomization device can be determined in advance.

In addition, the above variables such as the liquid density p and liquid flow quantity Q can be regarded as one or more optional variable parameters in the process of determining the initial fog droplet particle size D₁, and other variable parameters such as a liquid viscosity coefficient, a liquid temperature, and an agricultural chemical liquid concentration are possibly used separately or entirely. The atomization device spraying method disclosed in this application can provide a standard operation specification for manufacturing and use of components such as a first atomization disk 10 and a second atomization disk 20, so that the target fog droplets finally output by the atomization device that meets set requirements and has the target particle size D_{F} are qualitatively and quantitatively adjusted with a set value or a value approximate to the set value. Specific implementations for the atomization device spraying method and the atomization device disclosed in this application are described in detail as follows.

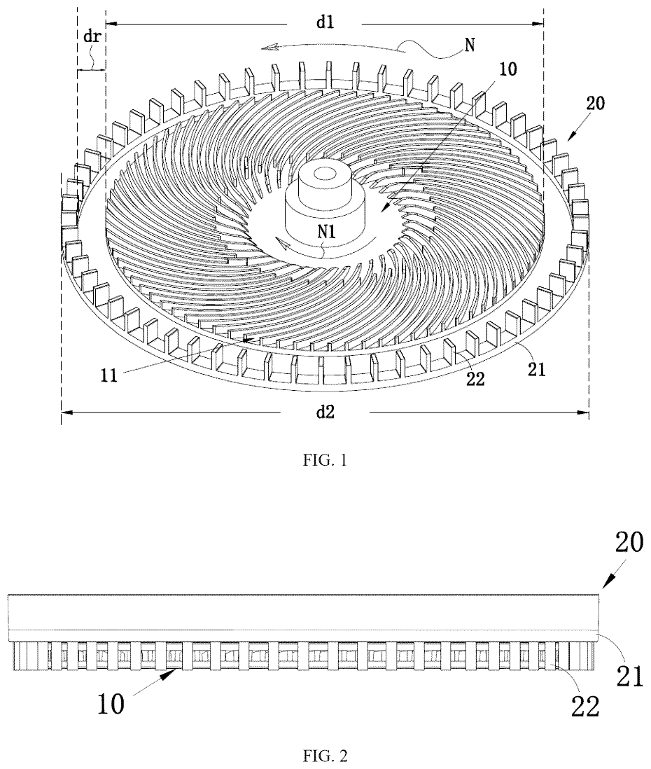

The atomization device spraying method is based on rotation control of the atomization device shown in FIG. 1 or FIG. 2, to determine and output the target fog droplets with the target particle size D_{F}. Unless otherwise specified, the particle size (for example, the initial fog droplet particle size D₁ or the target particle size D_{F}) related in this application is an average fog droplet particle size, namely, D₅₀. The atomization device includes the first atomization disk 10 and the second atomization disk 20 that are coaxially disposed in concentric circles and rotate in opposite directions. In an actual scenario, the spraying method can be regarded as a computer program execution logic and used for a communication session between a control side (or a background server) and a flight computer (for example, a flight control system) built into a drone.

The atomization device disclosed in this application includes the following steps.

First, obtain spraying parameters of the atomization device. The spraying parameters can be input in a graphical user interface of a control end in the mode of data input, so that the spraying parameters are transmitted to the flight control system (not shown) of the drone in a wireless or wired manner, and are calculated in the flight control system. Rotation of a first drive motor (not shown) and a second drive motor (not shown) that respectively drive the first atomization disk 10 and the second atomization disk 20 to rotate is determined, and the first atomization disk 10 and the second atomization disk 20 are respectively driven to reach corresponding rotating speeds that can respectively output target fog droplets with the target particle size D_{F}, namely, the target rotating speeds. Therefore, in this embodiment, the target rotating speeds can be understood as a rotating speed of the first atomization disk and a rotating speed of the second atomization disk, and the rotating speeds of the first atomization disk and the second atomization disk can be respectively controlled and adjusted.

Second, determine the target particle size D_{F} of the target fog droplets. Determining the target particle size D_{F} can be implemented before operation or during the start of the atomization device, to control the atomization device to finally output the target fog droplets with a target particle size conforming to the target particle size D_{F} or within a tolerable error of the target particle size D_{F}, namely, a target particle size D_{F} of 10 microns with a tolerance of +1 microns.

Next, adjust, based on the spraying parameters and a preset model, the rotating speed N of the second atomization disk to a target rotating speed for outputting the target fog droplets with the target particle size D_{F}, where the preset model is built by at least a secondary atomization factor α determined based on the rotating speed N of the second atomization disk. The rotating speed N of the second atomization disk is adjusted, to adjust the secondary atomization factor α, thereby adjusting the particle size of the fog droplets to the target particle size. After the initial fog droplet particle size D₁ is determined, the initial fog droplet particle size D₁ is compared with the set target particle size D_{F}, to determine whether to reduce or increase the rotating speed N of the second atomization disk, thereby adjusting the rotating speed N of the second atomization disk to the target rotating speed, and outputting target fog droplets that meets preset requirements.

Finally, perform spraying through the target fog droplets with the target particle size D_{F}. The target fog droplets are sprayed on plants under the action of a downward wind field formed by the rotation of a propeller of a drone.

The second atomization factor α is determined at least based on the rotating speed N of the second atomization disk 20 that rotates opposite to the first atomization disk 10 on an outer side of the first atomization disk, to use the secondary atomization factor α and the initial fog droplet particle size D₁ or to determine the target particle size of the target fog droplets output by the atomization device. Output of the target fog droplets with the target particle size D_{F} is determined by the preset model, and the preset model is the product of the initial fog droplet particle size D₁ output by the first atomization disk 10 and the secondary atomization factor α. To be specific, the preset model is D₁×α. It can be learned that the target fog droplets with the target particle size D_{F} can be further determined by an optimized preset model combined with the secondary atomization factor α.

The secondary atomization factor α is determined by the following formula: α=5.87×10⁻⁹×N²−2.18×10⁻⁴×N+2.15,
where a parameter N is the rotating speed of the second atomization disk.

The secondary atomization factor α is introduced to consider the influence of the rotating speed N of the second atomization disk on the target particle size D_{F} of the target fog droplets. Calculation efficiency and accuracy of the target particle size D_{F} can be improved by setting the secondary atomization factor α.

The initial fog droplet size D₁ of the initial fog droplets is determined by the following formula:

$${D}_{1} = \frac{k 1 \times {( ρ \times Q )}^{{k}_{2}}}{{( {N}_{1} \times d 1 )}^{{k}_{3}}} .$$

In the above formula, a spraying parameter N₁ is the rotating speed of the first atomization disk, a spraying parameter d₁ is the diameter of the first atomization disk, a spraying parameter p is a liquid density, a spraying parameter Q is a liquid flow quantity, a parameter k₁ is a first empirical coefficient, a parameter k₂ is a second empirical coefficient, and a parameter k₃ is a third empirical coefficient. The first empirical coefficient k₁ may be 45.96, the second empirical coefficient k₂ may be 0.24, and the third empirical coefficient k₃ may be 0.05, so that the formula for determining the initial fog droplet size D₁ is:

$${D}_{1} = \frac{45.96 \times {( ρ \times Q )}^{0.24}}{{( {N}_{1} \times {d}_{1} )}^{0.05}} .$$

Because only spraying parameters such as the spraying parameter N₁, spraying parameter d₁, spraying parameter ρ, and spraying parameter Q are introduced into the formula for determining the initial fog droplet particle size and are used as variables of the initial fog droplet particle size D₁, the initial fog droplet particle size D₁ of the initial fog droplets can be accurately determined. Further, the atomization device spraying method further includes: adjusting the spraying parameters, and adjusting the target particle size D_{F} of the target fog droplets based on the preset model. The spraying parameters include a combination of any one or more of the diameter d₁ of the first atomization disk, the liquid density ρ, the liquid flow quantity Q, and the rotating speed N₁ of the first atomization disk. In particular, the rotating speed N₁ of the first atomization disk can be adjusted to a target rotating speed.

In addition, several spiral-distributed guide grooves 11 are formed on a disk-shaped surface of the first atomization disk 10, and the guide grooves 11 may be guide grooves that can be distributed in the form of Archimedes curves. The guide grooves 11 may be formed on a disk-shaped upper surface and/or a disk-shaped lower surface of the first atomization disk 10. Liquid forming the target fog droplets is centrifugally accelerated through the guide grooves 11, and is torn at an edge of the first atomization disk 10 and decomposed into initial fog droplets with the initial fog droplet particle size D₁. In addition, an applicant pointed out that a quantity n of the guide grooves and the height h of the guide grooves formed in the first atomization disk 10 also have an effect on the target particle size D_{F} of finally output target fog droplets. Therefore, in this embodiment, the spraying parameters further include:
the quantity n of guide grooves and/or the height h of the guide groove on the first atomization disk 10;
The initial fog droplet size D₁ determined based on the optimized preset model is determined by the following formula:

$${D}_{1} = \frac{{k}_{5} \times {( ρ \times Q )}^{{k}_{2}}}{{( {N}_{1} \times {d}_{1} )}^{{k}_{3}}} \times {( h \times n )}^{{k}_{4}} ;$$

where the spraying parameter N₁ is the rotating speed of the first atomization disk, the spraying parameter d₁ is the diameter of the first atomization disk, the spraying parameter ρ is the liquid density, the spraying parameter Q is the liquid flow quantity, a parameter k₂ is a second empirical coefficient, a parameter k₃ is a third empirical coefficient, a parameter k₄ is a fourth empirical coefficient, and a parameter k₅ is a fifth empirical coefficient. The second empirical coefficient k₂ may be 0.24, the third empirical coefficient k₃ may be 0.05, the fourth empirical factor k₄ may be 0.12, and the fifth empirical factor k₅ may be 37.5. The quantity n of guide grooves and the height h of the guide groove are added to build the optimized preset model, so that the accuracy of the initial fog droplet particle size can be improved, and then the accuracy of the target fog droplet particle size determined based on the preset model conforming to a previously set target particle size D_{F} can be improved. Of course, a surface of the first atomization disk 10 may alternatively not be provided with the optimized preset model of the guide grooves 11, and only the preset model (or the optimized preset model) and the secondary atomization factor α are only used to jointly determine the target fog droplets with the target particle size D_{F}.

Further, with reference to the above formula, when the third empirical coefficient k₃ is a positive number less than 1, the diameter d₁ of the first atomization disk and/or the rotating speed N₁ of the first atomization disk are adjusted. In other words, the product of the rotating speed N₁ of the first atomization disk and the diameter d₁ of the first atomization disk is adjusted. As the product of the rotating speed N₁ of the first atomization disk and the diameter d₁ of the first atomization disk is larger, an output initial fog droplet particle size D₁ is smaller, otherwise, the initial fog droplet particle size D₁ is larger. In actual application, because the first atomization disk 10 is not easily replaced, the initial fog droplet particle size D₁ can be determined by fastening the diameter d₁ of the first atomization disk to adjust only the rotating speed N₁ of the first atomization disk to the target rotating speed.

Optionally, after the set value or a value approximate to the set value is selected, any one or more of the spraying parameters including the diameter d₁ of the first atomization disk, the rotating speed N₁ of the first atomization disk, the liquid density ρ, and the liquid flow quantity Q, and the preset model (or the optimized preset model) can be adjusted. At least the rotating speed N₁ of the first atomization disk and the rotating speed N of the second atomization disk are adjusted to respective target rotating speeds, and target rotating speeds corresponding to the rotating speed N₁ of the first atomization disk and the rotating speed N of the second atomization disk can be deduced reversely based on the determined target particle size D_{F}, so that the first atomization disk 10 outputs the initial fog droplet particle size D₁ of a set value or a value approximate to the set value, improving adjustment accuracy and an adjustment range of the initial fog droplet particle size.

Further, to improve the efficiency and accuracy for determining the target particle size D_{F}, the initial fog droplet particle size can also be selected, and then the rotating speed N of the second atomization disk is adjusted, so that the second atomization disk 20 outputs the target particle size of a set value or a value approximate to the set value. To be specific, after the initial fog droplet particle size is determined, the spraying parameters such as the rotating speed N₁ of the first atomization disk and the diameter d₁ of the first atomization disk have been determined, and then quantitative adjustment of the target particle size D_{F} can be implemented by adjusting only the rotating speed N of the second atomization disk.

A minimum value of the initial fog droplet particle size is selected as 70 microns, and a set value or a value approximate to the set value of the target particle size D_{F} of 20-25 microns is selected, so that the rotating speed N or a rotating speed range of the second atomization disk can be directly determined, to reduce a difficulty in adjusting the rotating speed N of the second atomization disk. Through accurate adjustment of the rotating speed N₁ of the first atomization disk and the rotating speed N of the second atomization disk, quantitative adjustment of the target particle size D_{F} is implemented, so that the target particle size D_{F} is adjusted to possibly conform to the set value or be approximate to the set value, and the applicability of the atomization device is improved.

In this embodiment, the rotating speed N₁ of the first atomization disk is greater than the rotating speed N of the second atomization disk. Because the diameter d₁ of the first atomization disk is smaller than the diameter d₂ of the second atomization disk, an overall energy utilization rate can be improved, and damage to or jitter of the second atomization disk 20 due to an excessively large diameter or an excessively great rotating speed can be avoided, thereby improving the service life of the atomization device. Further, a difference between the rotating speed N₁ of the first atomization disk and the rotating speed N of the second atomization disk is greater than or equal to 5,000 rpm, namely, N₁−N≥5,000 rpm, to ensure that the target particle size D_{F} can be small enough (for example, less than 50 microns), and ensure the service life of the atomization device. For example, the rotating speed N₁ of the first atomization disk is greater than or equal to 15,000 rpm and less than or equal to 30,000 rpm, and the rotating speed N of the second atomization disk is greater than or equal to 10,000 rpm.

In addition, the rotating speed N₁ of the first atomization disk shall not be less than 5,000 rpm, and the diameter of the first atomization disk is d₁≥10 cm, to achieve initial fog droplet particle size≤preset value, preventing that the target particle size cannot reach an expected value (namely, a set value of the target particle size or a value approximate to the set value) due to the excessively large initial fog droplet particle size, and improving adjustment efficiency of the target particle size D_{F}.

It should be noted that the applicant found through experimental verification that the particle size of the fog droplets produced by the first atomization disk 10 has a minimum value. When the minimum value is reached, in a case that the liquid density p and the liquid flow quantity Q remain unchanged, the target particle size D_{F} of the target fog droplets cannot be reduced even if the rotating speed N₁ of the first atomization disk and the diameter d₁ of the first atomization disk are increased. Therefore, the initial fog droplet particle size≥ minimum value.

In an optional embodiment, the initial fog droplet particle size is determined to be equal to the minimum value, to improve the overall energy utilization rate of the atomization device, prevent excessively energy from being lost due to the excessively great rotating speed of the first atomization disk 10, and ensure that the initial fog droplet particle size D₁ formed by the fog droplets output by the first atomization disk 10 is small enough, and further reduce the target particle size D_{F}. The minimum value is reasonably selected based on an environment (e.g., an air temperature, a wind speed, an air pressure, or the like) in which the atomization device is located, the liquid density ρ, the liquid flow quantity Q, and tiny changes in the target particle size D_{F} caused by changes in a structure of the device. For example, the minimum value may be equal to 60 microns, 65 microns, 70 microns, 75 microns, 80 microns, or the like.

In this application, after the first atomization disk 10 is disposed to obtain the initial fog droplets with the initial fog droplet particle size D₁, the rotating speed N of the second atomization disk is provided, so that the target fog droplets with the target particle size D_{F} are output, and the target particle size of the target fog droplets output by the atomization device can be smaller than the initial fog droplet particle size and further smaller than the minimum value of the initial fog droplet particle size. The target particle size D_{F} can reach 60 microns, 50 microns, 40 microns, 30 microns, 20 microns, or even 10 microns, and the target particle size D_{F} of the atomization device can be adjusted in a particle size distribution range of 10-60 microns, so that an application range of the atomization device is increased. After the initial fog droplet particle size D₁ has been determined (to be specific, the rotating speed of the first atomization disk and the diameter of the first atomization disk have been determined), as long as the rotating speed N of the second atomization disk is directly adjusted, the target fog droplets with the target particle size D_{F} can be determined and output, so that a difficulty in controlling the target particle size D_{F} of the target fog droplets output by the atomization device is greatly reduced, the efficiency and accuracy for determining the target particle size D_{F} are improved, a target particle size that has been input and determined by a user is exactly the same as the target particle size D_{F} actually output by the atomization device, and the accuracy of the actually output target particle size D_{F} can be ensured.

The following is a detailed description of the atomization device: the atomization device is provided with a first atomization disk 10 and a second atomization disk 20 coaxially disposed, an outer edge of the second atomization disk 20 is provided with an annular body 21, a spacing dr is formed between the outer edge of the first atomization disk 10 and the annular body 21 along a radial direction, and the spacing dr=1-4 mm. The annular body 21 includes teeth 22 spaced apart along a circumferential direction of the second atomization disk 20. After the spacing dr is formed, the initial fog droplets can be fully torn apart by the air in an annular area formed by the spacing dr in a transverse flight process, and an initial fog droplet spraying annular-surface is formed. In addition, because the spacing is relatively small, it is prevented that the initial fog droplets lose excessive kinetic energy in the transverse flight process, so that the initial fog droplets are further cracked and accelerated as droplets with a smaller particle size and basically with a set value of the target particle size or approximate to the set value under the action of the teeth 22 that rotate at a high-speed, ensuring the qualitative and quantitative adjustment effect of the target particle size D_{F}.

The applicant presents test results and a verification analysis process based on the above technical solutions.

The target fog droplets with the target particle size D_{F} are formed based on both first atomization performed by rotation of the first atomization disk 10 and second atomization performed by rotation of the second atomization disk 20. For example, the liquid flow quantity Q is 0.5 L/min, the diameter d₁ of the first atomization disk is 0.1 m, the diameter d₂ of the second atomization disk is 0.104 m, and the spacing dr=2 mm. Liquid to be sprayed is water with a liquid density p of 1,000 kg/m³.

The test environment is room temperature (23° C.), and the first atomization disk 10 and the second atomization disk 20 are adjusted at different rotating speeds. Through an OMEC laser particle size analyzer, in a case that the rotating speeds of the first atomization disk 10 and the second atomization disk 20 remain unchanged, ten groups of data of the initial fog droplet particle sizes (the initial fog droplet particle size D₁ determined by the spraying parameter ρ, the spraying parameter Q, the spraying parameter N₁, and the spraying parameter d₁) and the target particle sizes are tested respectively, and average values of the initial fog droplet particle sizes and the target particle sizes are obtained respectively, so that a tested standard value of the initial fog droplet particle size rotatably output by the first atomization disk 10 and a tested standard value of the target particle size rotatably output by the second atomization disk are obtained, as shown in Table 1 below.

TABLE 1

| | | | | | | Tested | |
|---|---|---|---|---|---|---|---|
| | | | | | | standard | Tested |
| | | | | | | value of | standard |
| | | | | | | the initial | value |
| | | | | | | fog droplet | (microns) |
| | | | | | | particle | of the target |
| | | | | | | size D₁ | particle |
| N₁ | N | d₁ | d₂ | ρ | Q | (microns) | size D_{F} |
| 15,000 | 10,000 | 0.1 | 0.104 | 1,000 | 0.5 | 70 | 40 |
| 19,000 | 12,000 | 0.1 | 0.104 | 1,000 | 0.5 | 70 | 30 |
| 24,000 | 13,000 | 0.1 | 0.104 | 1,000 | 0.5 | 70 | 20 |
| 27,000 | 20,000 | 0.1 | 0.104 | 1,000 | 0.5 | 70 | 10 |

Through Table 1, it can be learned that when the rotating speed N₁ of the first atomization disk is between 15,000-27,000 rpm, the tested standard value of the initial fog droplet particle size is always 70 microns. In addition, as the rotating speed N₁ of the first atomization disk is gradually increased to 27,000 rpm and the rotating speed N of the second atomization disk is gradually increased to 20,000 rpm, the tested standard value of the target particle size of all the target fog droplets output by the atomization device is finally kept around 10 microns.

Based on this, to verify the accuracy and rationality of the initial fog droplet particle size D₁, the applicant selected five discrete values of the rotating speeds of the first atomization disk N₁ including 1,000 rpm, 15,000 rpm, 19,000 rpm, 2,4000 rpm, and 27,000 rpm respectively to calculate a theoretical value of the initial fog droplet particle size D₁, where k₂=0.24, k₃=0.06, k₄=0.12, k₅=37.5. Results are shown in a third row to a sixth row in Table 2 below, and an error between the tested standard value of the initial fog droplet particle size D₁ and a theoretical value is within ±5%. In addition, after the rotating speed of the first atomization disk 10 is gradually increased, it can be learned, from the tested standard value of the initial fog droplet particle size determined based on an optimized preset model with a quantity n of guide grooves and the height h of the guide groove introduced into a second row to a fifth row, that the values are approximate to 70 microns. To be specific, a minimum value of the initial fog droplets output by the first atomization disk 10 is 70 microns, which conforms to the actual law. When a first row shows that the rotating speed N₁ of the first atomization disk is 1,000 rpm, the target particle size finally output by the atomization device is 82.580 microns, which is obviously less than the tested standard value of the initial fog droplet particle size of 100 microns. Therefore, the rotating speed of the first atomization disk is N₁≥10,000 rpm, preventing an excessively great error from the initial fog droplet particle size.

TABLE 2

| | | | | | | | | Tested |
|---|---|---|---|---|---|---|---|---|
| | | | | | | | Theoretical | standard |
| | | | | | | | value of | value of |
| | | | | | | | the initial | the initial |
| | | | | | | | fog droplet | fog droplet |
| N₁ | d₁ | d₂ | ρ | Q | h | n | particle size | particle size |
| (rpm) | (m) | (m) | (1 kg/L) | (L/min) | (m) | (quantity) | (microns) | (microns) |
| 1,000 | 0.1 | 0.104 | 1,000 | 0.5 | 0.00153 | 120 | 82.580 | 100 |
| 15,000 | 0.1 | 0.104 | 1,000 | 0.5 | 0.00153 | 120 | 72.123 | 70 |
| 19,000 | 0.1 | 0.104 | 1,000 | 0.5 | 0.00153 | 120 | 71.275 | 70 |
| 24,000 | 0.1 | 0.104 | 1,000 | 0.5 | 0.00153 | 120 | 70.447 | 70 |
| 27,000 | 0.1 | 0.104 | 1,000 | 0.5 | 0.00153 | 120 | 70.034 | 70 |

Then, the rationality and accuracy of a secondary atomization factor α are verified. To determine the target particle size more simply, the target particle size is calculated by using the rotating speed N of the second atomization disk, to conform to an atomization law of the atomization device. Further, the applicant sets the secondary atomization factor α to a polynomial based on the rotating speed N of the second atomization disk, to further match the atomization law based on which the atomization device outputs the target fog droplets that conform to the target particle size D_{F} that has been determined. Four discrete values including 10,000 rpm, 12,000 rpm, 13,000 rpm, and 20,000 rpm of the rotating speeds N of the second atomization disk are selected, to calculate fitting coefficients (namely, a coefficient a0, a coefficient a1, and a coefficient a2). To be specific, three coefficients (namely, a coefficient a0, a coefficient a1, and a coefficient a2) of a polynomial of the secondary atomization factor α are determined respectively, and the secondary atomization factor satisfies α=a0× N₂+a1× N+a2. Coefficient fitting is implemented by MATLAB.

Finally, a theoretical value of the target particle size D_{F} (namely, the target particle size determined based on a preset model of D_{F}=D₁×α) is determined based on an optimized preset model of the preset model determined with an introduced quantity n of guide grooves and height h of the guide groove determined based on the second atomization factor α, which is specifically shown in Table 3 below.

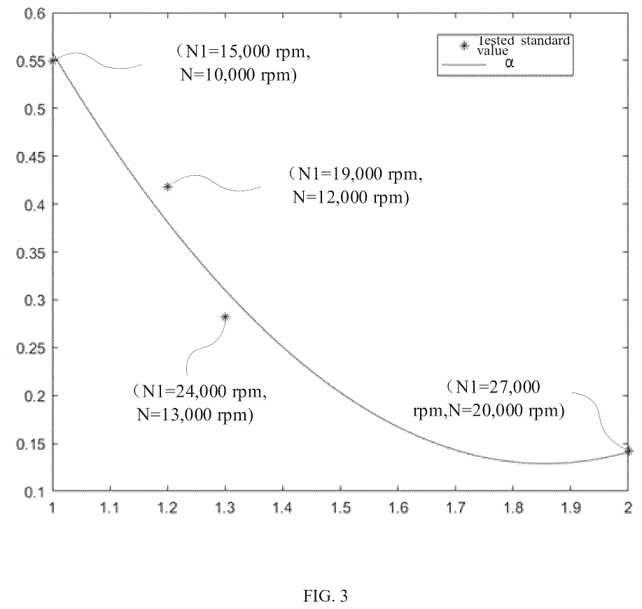

It is verified through Table 3 whether the three coefficients of the secondary atomization factor α are correct. An abscissa in FIG. 3 is the rotating speed N (unit: rpm) of the second atomization disk, and an ordinate is a ratio of the target particle size to the initial fog droplet particle size. The theoretical value of the target particle size D_{F} of each coefficient of the secondary atomization factor α is determined based on the determined secondary atomization factor α.

TABLE 3

| Theoretical | | | | | | Tested |
|---|---|---|---|---|---|---|
| value of the | | | | | | standard |
| initial fog | | | | | | value |
| droplet size | | | | | Theoretical | (microns) |
| determined based | | | | | value | of the target |
| on the optimized | Coefficient | Coefficient | Coefficient | | (microns) | particle |
| preset model | a0 | a1 | a2 | N | of D_{F} | size D_{F} |
| 72.123 | 5.87 × 10⁻⁹ | −0.000218 | 2.15 | 10,000 | 40.172 | 40 |
| 71.275 | 5.87 × 10⁻⁹ | −0.000218 | 2.15 | 12,000 | 27.033 | 30 |
| 70.447 | 5.87 × 10⁻⁹ | −0.000218 | 2.15 | 13,000 | 21.700 | 20 |
| 70.034 | 5.87 × 10⁻⁹ | −0.000218 | 2.15 | 20,000 | 9.665 | 10 |

The theoretical value of the initial fog droplet size in Table 3 is obtained based on parameters in Table 2, and the theoretical value of the target particle size D_{F} is calculated by substituting the rotating speed N of the second atomization disk. In the same case, the tested standard values of the target particle size D_{F} are respectively 40 microns, 30 microns, 20 microns, and 10 microns. Theoretical values of the target particle size D_{F} finally generated by the initial fog droplet size determined based on the optimized preset model in Table 3 are respectively 40.172 microns (with an error from a tested standard value of a target particle size D_{F} determined based on the rotating speed N of the second atomization disk in Table 1 is +0.43%), 27.033 microns (with an error from a tested standard value of a target particle size D_{F} determined based on the rotating speed N of the second atomization disk in Table 1 is −9.89%), 21.700 microns (with an error from a tested standard value of a target particle size D_{F} determined based on the rotating speed N of the second atomization disk in Table 1 is +8.50%), and 9.665 microns (with an error from a tested standard value of a target particle size D_{F} determined based on the rotating speed N of the second atomization disk in Table 1 is −3.35%). It can be learned that an error between the theoretical value and an actually measured value of the target particle size D_{F} of the target fog droplets generated in the atomization device spraying method disclosed in this embodiment are all below ±10% and is consistent with FIG. 3. Therefore, coefficients and parameters of the secondary atomization factor α are all relatively accurate.

Based on the spraying method disclosed in the above embodiment, this embodiment further discloses an atomization device, including a first atomization disk 10 and a second atomization disk 20 that are coaxially disposed in concentric circles and rotate in opposite directions. The above atomization device spraying method is used for the atomization device, to output target fog droplets with a target particle size D_{F}. An outer edge of the second atomization disk 20 is provided with an annular body 21, the annular body 21 is provided with a circle of teeth 22 along a circumferential direction thereof at intervals, and the teeth 22 partially overlap an initial fog droplet spraying annular-surface formed by the initial fog droplets output by the first atomization disk 10, so that the initial fog droplets can be further torn into target fog droplets with a smaller particle size by the teeth 22 that rotate at a high speed.

Optionally, the teeth 22 are arranged vertically upwards as shown in FIG. 1, or the teeth 22 are arranged vertically downwards, obliquely upwards, or obliquely downwards as shown in FIG. 2. It should be noted that positions of the first atomization disk 10 and the second atomization disk 20 in an axial direction are not restricted. The first atomization disk 10 can be disposed above the second atomization disk 20, or the first atomization disk 10 can alternatively be disposed below the second atomization disk 20, as long as the teeth 22 are disposed on an outer side of the first atomization disk 10, and can overlap the initial fog droplet spraying annular-surface formed by the initial fog droplets output by the first atomization disk 10. Further, the teeth 22 may be perpendicular to a disk surface of the second atomization disk 20, as shown in FIG. 1 and FIG. 2, or may alternatively be inclined to the disk surface of the second atomization disk 20 (not shown). Specifically, the teeth 22 may alternatively be inclined inward or inclined outward with the disk face of the second atomization disk 20. The atomization device disposed based on the above embodiment can be applied to a drone. The drone includes a frame with a dynamic mechanism and at least one atomization device as disclosed in the above embodiment.

The atomization device can be suspended at the bottom or on a side back of the frame, and preferably disposed below a power mechanism of the drone (for example, a motor disposed at an end of a cantilever of a quadrotor drone) to perform atomization spraying on a to-be-sprayed object (such as a fruit tree) through target fog droplets with a target particle size D_{F} output by the atomization device by using a downward pressure wind field generated by the power mechanism, and adhere the target fog droplets to leaf surfaces of the fruit tree, to reduce a waste of agricultural chemical liquid and improve penetration power of the fog droplets. In addition, the rotating speed N of the second atomization disk and one or more spraying parameters, (for example, the rotating speed N₁ of the first atomization disk, the liquid flow quantity Q, and the like), that can be adjusted during the flight of the drone are adjusted based on an actual temperature, and a wind speed of weather, so that the target particle size D_{F} is adjusted, or even the first atomization disk 10 and/or the second atomization disk 20 can be replaced (namely, the diameter d₁ of the first atomization disk and/or the diameter d₂ of the second atomization disk can be adjusted), so that the target particle size D_{F} is adjusted. A method for determining the target particle size D_{F} output by the atomization disk is described above and is not repeated herein.

A series of detailed descriptions listed above are only specific descriptions of feasible embodiments of the present invention and are not intended to limit the scope of protection of the present invention, and equivalent implementations or changes that are made in the spirit of the present invention shall be included in the scope of protection of the present invention.

For those skilled in the art, it is clear that the present invention is not limited to the details of the above exemplary embodiments, and the present invention can be implemented in other specific forms without departing from the spirit or essential features of the present invention. Therefore, from any point of view, the embodiments should be regarded to be exemplary and non-restrictive, and the scope of the present invention is limited by the attached claims and not by the above description. Therefore, all changes in the meaning and scope of the equivalent elements of the claims are intended to be within the present invention. Any numerals in the claims shall not be deemed to be a limitation of related claims.

In addition, it should be understood that although the specification is described in accordance with the implementations, but not each embodiment includes only one separate technical solution. The description of the specification is only for the sake of clarity. Those skilled in the art should regard the specification as a whole, and the technical solutions in all embodiments may also be properly combined to form other implementations that can be understood by those skilled in the art.

What is claimed is:

1. An atomization device spraying method, wherein an atomization device comprises a first atomization disk and a second atomization disk, the first atomization disk and the second atomization disk are coaxially disposed and rotate in opposite directions, a diameter of the first atomization disk is smaller than a diameter of the second atomization disk, and the atomization device spraying method comprises:
obtaining spraying parameters of the atomization device;
determining a target particle size D_{F} of target fog droplets;
adjusting, based on the spraying parameters and a preset model, a rotating speed N of the second atomization disk to a target rotating speed for outputting the target fog droplets with the target particle size D_{F}, wherein the preset model is built by at least a secondary atomization factor α determined based on the rotating speed N of the second atomization disk; and
performing spraying through the target fog droplets with the target particle size D_{F},
wherein the preset model is a product of an initial fog droplet particle size D₁ output by the first atomization disk and the secondary atomization factor α; and
the secondary atomization factor α is determined by the following formula:
$$α = 5.87 \times 1 {0}^{- 9} \times {N}^{2} - 2.18 \times 1 {0}^{- 4} \times N + 2.15 .$$

2. The atomization device spraying method according to claim 1, further comprising: adjusting the spraying parameters, and adjusting the target particle size D_{F} of the target fog droplets based on the preset model, wherein the spraying parameters comprise at least one of the diameter d₁ of the first atomization disk, a liquid density ρ, a liquid flow quantity Q, and a rotating speed N₁ of the first atomization disk.

3. The atomization device spraying method according to claim 2, wherein the initial fog droplet particle size D₁ is determined by the following formula:
$${D}_{1} = \frac{{k}_{1} \times {( ρ \times Q )}^{{k}_{2}}}{{( {N}_{1} \times {d}_{1} )}^{{k}_{3}}} ;$$
wherein a parameter k₁ is a first empirical coefficient, a parameter k₂ is a second empirical coefficient, and a parameter k₃ is a third empirical coefficient.

4. The atomization device spraying method according to claim 2, wherein the spraying parameters comprise: a quantity n of guide grooves and/or a height h of each of the guide grooves in the first atomization disk; and
the initial fog droplet particle size D₁ is determined by the following formula:
$${D}_{1} = \frac{{k}_{5} \times {( ρ \times Q )}^{{k}_{2}}}{{( {N}_{1} \times {d}_{1} )}^{{k}_{3}}} \times {( h \times n )}^{{k}_{4}} ;$$
wherein a parameter k₂ is a second empirical coefficient, a parameter k₃ is a third empirical coefficient, a parameter k₄ is a fourth empirical coefficient, and a parameter k₅ is a fifth empirical coefficient.

5. The atomization device spraying method according to claim 2, further comprising:
respectively adjusting the rotating speed N₁ of the first atomization disk and the rotating speed N of the second atomization disk to respective target rotating speeds based on the diameter d₁ of the first atomization disk, the liquid density ρ, the liquid flow quantity Q, and the preset model, to output the target fog droplets with the target particle size D_{F}.

6. The atomization device spraying method according to claim 2, wherein the rotating speed N₁ of the first atomization disk is ∈[15,000 rpm, 30,000 rpm], and a difference between the rotating speed N₁ of the first atomization disk and the rotating speed N of the second atomization disk is greater than or equal to 5,000 rpm.
